(19) United States
(12) Patent Application Publication
(10) Pub. No.: US 2003/0091112 A1
(43) Pub. Date: May 15, 2003

(54) Display method for stabilizing MPEG video output via an LCD device

(76) Inventor: Li-Yi Chen, Tainan Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/065,716

(22) Filed: Nov. 13, 2002

(30) Foreign Application Priority Data
Nov. 15, 2001 (TW) 090128379

(51) Int. Cl. H04N 7/12

(52) U.S. Cl. 375/240.15; 348/441

(57) ABSTRACT

A display method is provided for stabilizing MPEG video output via an LCD device. The MPEG video has a plurality of intra-frames (I-frames) for providing full picture image data, a plurality of predict-frames (P-frames) for providing both motion vectors and partial picture image data, and a plurality of bi-directional predict-frames (B-frames) for providing only motion vectors. When an MPEG decoder decodes the P-frames and the B-frames for retrieving motion vectors, an up converter operates simultaneously for interpolating at least one frame between two consecutive frames using the motion vectors so as to increase a frame rate of the picture images.

### BACKGROUND OF INVENTION

1. Field of the Invention

The present invention relates to a display method for displaying MPEG video output, and more specifically, the present invention discloses a display method for stabilizing MPEG video output via an LCD device.

2. Description of the Prior Art

The advantages of an LCD device include portability, low power consumption, and low radiation. Therefore, the LCD device is widely used in various portable products, such as notebooks, personal data assistants (PDA), etc. Moreover, the LCD device is gradually replacing the CRT monitor in desktop computers. Nevertheless, the LCD device displays different colors by way of changing arrangement of liquid crystal molecules so as to display picture images. Therefore, outputted images of the LCD device are less clear and stable than outputted images of the CRT monitor due to characteristics of the liquid crystal molecule itself.

Please refer to FIG. 1. FIG. 1 is a diagram of picture images displayed on a display panel of an LCD device according to the prior art. As shown in FIG. 1, a horizontal axis indicates time, and a vertical axis indicates position. When an object moves from time “0” and position “0” to time t6 and position X6 along a straight line, a position vs. time relationship should be a dotted line L1 shown in FIG. 1. The LCD device is substantially a hold-type display device. Therefore, if movement states of the object are displayed by the LCD device, the picture images of the object displayed on the display panel of the LCD device are discontinuous. As a line L2 shows, the position of the object is maintained on position “0” during a time interval from time “0” to time tl, and moved from position “0” to position X1 at time t1. The aforementioned moving process of the object will cause the display panel of the LCD device to be blurred, and further reduce image quality of the displayed picture images. Picture experts decoding technology is widely used in related fields of image media such as TV, communications, computers, etc. Therefore, image systems using motion picture experts group (MPEG) video such as high-definition television (HDTV) and digital video broadcasting (DVB) have caused a great improvement in displaying and transmitting images. The MPEG technology cannot only provide high-quality visual and audio effects, but also effectively solve transmission bandwidth problems.

To compress the picture images, the first step is to digitize the picture image signals by way of sampling and quantization processes. The sampling process is used to capture a plurality of discrete signals within the continuous analog image signals to represent the image signals. That is, the sampling process can determine resolution of the image signals. The quantization process is used to digitize shading values of gray levels of the picture images. An MPEG image compression process is achieved mainly by two technologies. One technology utilizes block-based motion compensation to reduce redundant messages on time domain. The other technology utilizes transform-domain-based compression to reduce amounts of data stored on frequency domain. In other words, the block-based motion compensation is used to cancel repetitive data. That is, if two picture frames both commonly comprise an image element, after the first picture frame has completely transmitted data including the image element, the second picture frame needs only to transmit data not including the image element. The transform-domain-based compression is used to transform the image data from the time domain onto the frequency domain through a discrete cosine transform (DCT) method to eliminate high frequency portions which are not visible by human eyes. Therefore, the amount of image data is reduced so as to perform digital transmission under a limited bandwidth.

Please refer to FIG. 2. FIG. 2 is a diagram of an MPEG video output according to the prior art. As shown in FIG. 2, the MPEG technology with different definitions for different frame standards will be described below. An inter-frame (I-frame) decodes the image data of a full screen so that the I-frame needs a larger capacity to store the image data of the frame. A predict-frame (P-frame) utilizes the preceding I-frame or the preceding P-frame to perform a motion estimation process so as to obtain a motion vector. Therefore, the P-frame comprises partial image data and computed vectors, which are different from the preceding I-frame or the preceding P-frame. A bi-directional-frame (B-frame) is obtained by computing two adjacent I-frames or P-frames, the B-frame comprising only motion vector data. Therefore, the MPEG technology utilizes the I-frames, P-frames, and B-frames to produce image output while displaying the picture image frames. For example, the MPEG technology will firstly decode an I-frame 11 and a P-frame P4. Then, the preceding I-frame 11 and the preceding P-frame P4 are decoded and thus produce two B-frames B2 and B3 since decoding the I-frame 11 and the P-frame P4 produces the two B-frames. Finally, the picture image frames will be orderly displayed as follows.

I1, B2, B3, P4, B5, B6, P7, B8, B9, I10 If image data adopting the MPEG technology (such as MPEG-2 and MPEG-4 films) are displayed by a hold-type display device (such as an LCD device), the frame rate of the hold-type display device will be influenced due to a lower frame turnover rate of the image data. Thus, the image frame of an object moving in the display panel will be disturbed and blurred.

### SUMMARY OF INVENTION

It is therefore a primary objective of the claimed invention to provide a display method for increasing a frame turnover rate of picture images so as to stabilize MPEG video output via an LCD device.

The claimed invention, briefly summarized, discloses a display method for stabilizing MPEG video output via an LCD device. The MPEG video has a plurality of intra-frames (I-frames) for providing full picture image data, a plurality of predict-frames (P-frames) for providing both motion vectors and partial picture image data, and a plurality of bi-directional predict-frames (B-frames) for providing only motion vectors. When an MPEG decoder decodes the P-frames and the B-frames for retrieving motion vectors, an up converter operates simultaneously for interpolating at least one frame between two consecutive frames using the motion vectors so as to increase a frame rate of the picture images.

It is an advantage of the claimed invention that the claimed display method utilizes motion vectors stored in the prior P-frame and B-frame to interpolate frames between two consecutive frames so as to increase frame rate of the LCD device.

Therefore, the claimed invention cannot only reserve the compressed picture image data, but also increase the frame turnover rate so as to clearly output the images through an LCD device.

These and other objectives and advantages of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of picture images displayed on a display panel of an LCD device according to the prior art.

FIG. 2 is a diagram of an MPEG video output according to the prior art.

FIG. 3 is a diagram of a decoded image of the MPEG video output according to the prior art.

FIG. 4 is a diagram of a decoded image according to the present invention.

FIG. 5 is a diagram of picture images displayed on a display panel of an LCD device according to the present invention.

FIG. 6 is a contrast diagram of picture images displayed on a display panel of the present LCD device and the prior LCD device.

### DETAILED DESCRIPTION

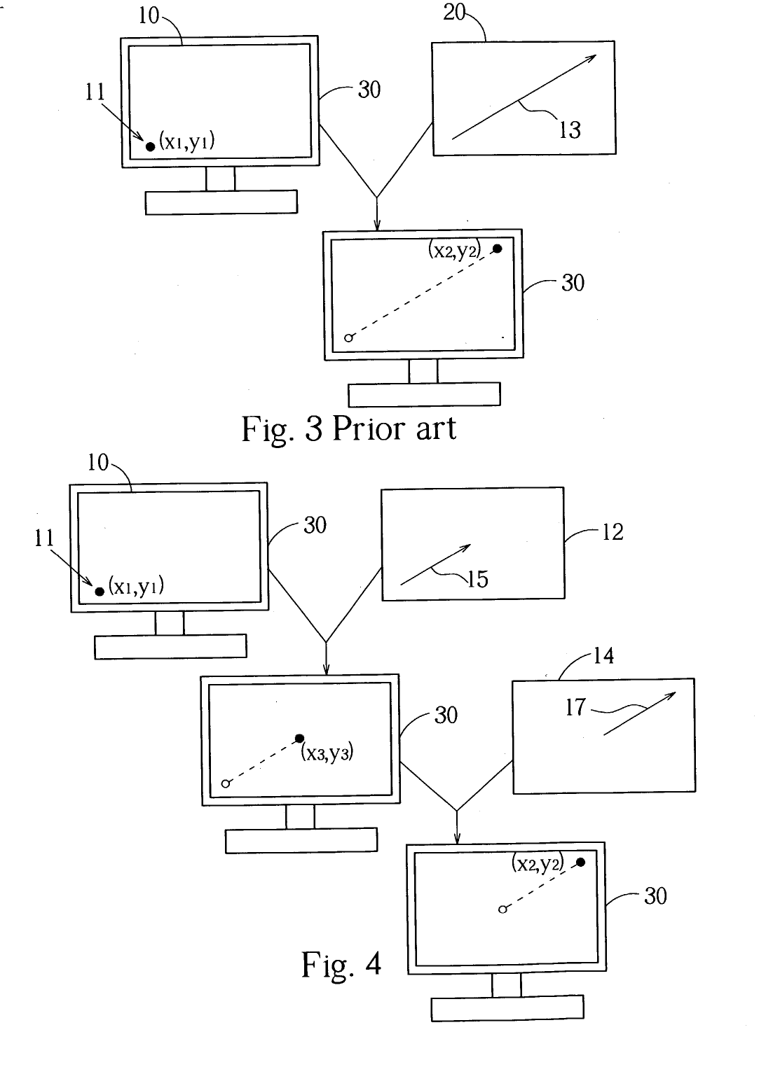

Please refer to FIG. 3 and FIG. 4. FIG. 3 is a diagram of a decoded image of MPEG video output according to the prior art. FIG. 4 is a diagram of a decoded image according to the present invention. As shown in FIG. 3, an I-frame I0 (also can be a P-frame) comprises a pixel datum 11 located at a display position (x1,y1) of a screen 30, a B-frame 20 (also can be a P-frame) comprises a motion vector 13 (x2-x1,y2-y1) for recording moving states of the pixel datum 11. Therefore, after an MPEG decoder decodes the I-frame 10 and P-frame 20, a picture image of the pixel datum 11 moving from the display position (x1,y1) to a display position (x2,y2) is displayed on the screen 30.

As shown in FIG. 4, the preferred embodiment of the present invention divides the motion vector 13 in the B-frame 20 into a motion vector 15 (x3-x1,y3-y1) stored in a B-frame 12, and a motion vector 17 (x2-x3,y2-y3) stored in a B-frame 14 when performing a decoding process. The MPEG decoder decodes the I-frame 10 and the B-frame 12, and then displays the picture image of the pixel datum 11 on the screen 30 by moving the display position (x1,y1) to a display position (x3,y3). Similarly, the MPEG decoder decodes the B-frame 14, and then displays the picture image of the pixel datum 11 on the screen 30 by moving the display position (x3,y3) to the display position (x2,y2). When the MPEG decoder decodes the compressed image datum 11, the present invention performs a vector computation process for the motion vector 13 to produce two motion vectors 15 and 17 so as to smoothly display the picture image of the pixel datum 11 on the screen 30 by moving the display position (x1,y1) to the display position (x2,y2) through the display position (x3,y3).

The MPEG technology has defined the P-frame and B-frame as both including motion vectors, so the present invention utilizes an up converter to perform the vector computation process for the P-frames and the B-frames to interpolate at least one B-frame which only includes the motion vectors between two consecutive frames so as to increase a number of displayed image frames and the frame rate of the picture images. If the motion vectors of the P-frame and the B-frame are divided into more motion vectors, more interpolated B-frames are produced to increase the frame turnover rate and produce a smooth image output.

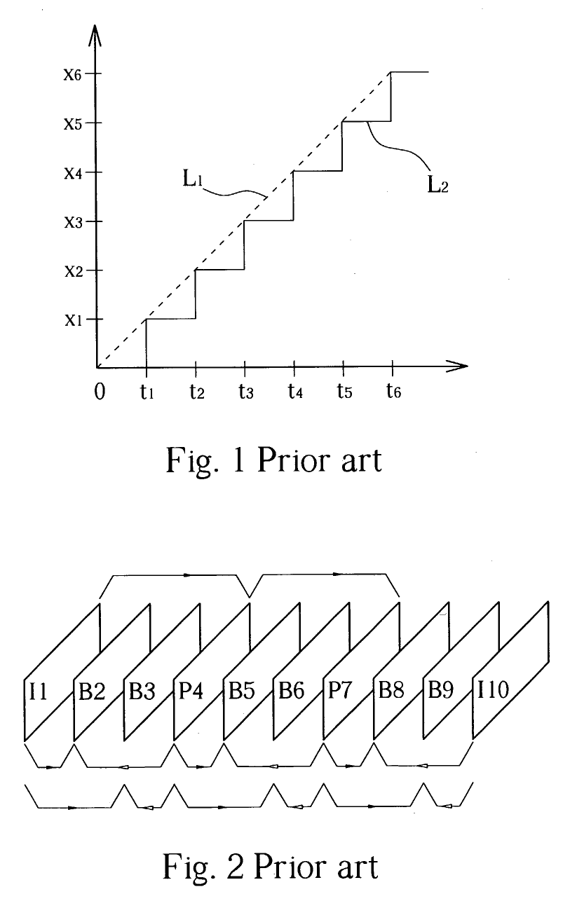

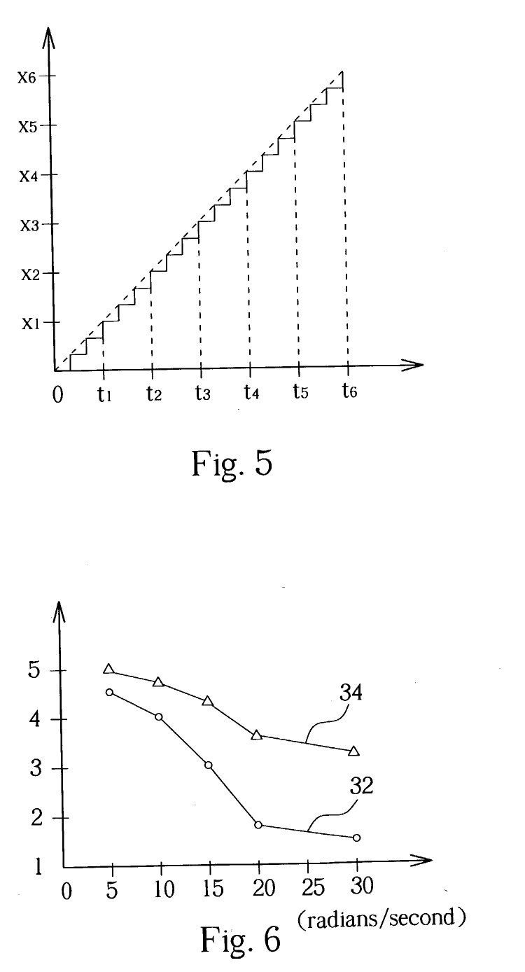

Please refer to FIG. 5. FIG. 5 is a diagram of the picture images displayed on the display panel of the LCD device according to the present invention. This preferred embodiment of the present invention utilizes motion vectors of each P-frame and each B-frame to interpolate two frames between two consecutive frames. Therefore, when an object is moved from position “0” to position X6, the present LCD device will output more frames than the prior LCD device (shown in FIG. 1) so as to smoothly move the object.

Please refer to FIG. 6. FIG. 6 is a contrast diagram of picture images displayed on a display panel of the present LCD device and the prior LCD device. As shown in FIG. 6, a horizontal axis indicates angular velocity caused while a picture image in the frame is moved relative to a user, and a vertical axis indicates influenced degrees of the sense of sight of the user when the picture image is moved. A scale 1 of the vertical axis means that the picture image is non-smoothly moved and blurred, and when the scale of the vertical axis is 5, the sense of sight of the user is almost not capable of detecting disturbances and blurs caused when the object is moved. A characteristic curve 32 displays influence upon the sense of sight of the user caused by the moving picture image according to the outputted frame of the prior LCD device. A characteristic curve 34 displays influence upon the sense of sight of the user caused by the moving picture image after the frame rate of the LCD device is doubled, according to the outputted frame of the present LCD device. When a picture image of the frame is substantially moved, a larger relative angular velocity for the user will be produced. For example, if the relative velocity is 30 radians/second for the user, the moving picture image will cause serious disturbance and blurs for the user. If the frame rate of the LCD device is doubled, the disturbance and blurs for the user will be substantially improved so as to stabilize the image frame output. For example, when the user utilizes an LCD device to view an MPEG-2 video in a digital versatile disc (DVD), the preferred embodiment of the present invention utilizes all P-frames and B-frames stored in two I frames to directly compute motion vectors recorded in each P-frame and each B-frame. The up converter is used for generating a number of interpolated frames so as to double the frame rate of the MPEG-2 video, and further double the frame turnover rate so as to stabilize the output of the LCD device.

The method of utilizing the motion vectors stored in the P-frames and the B-frames to interpolate a plurality of frames between two consecutive frames can also be applied in a plasma display panel (PDP) of the hold-type display devices to substantially increase image quality of the MPEG video output.

In contrast to the prior art, the present display method utilizes motion vectors stored in the prior P-frame and B-frame to interpolate frames between two consecutive frames so as to increase frame rate of the LCD device. Therefore, the present invention cannot only reserve the compressed picture image data, but also increase the frame turnover rate so as to clearly output the images through an LCD device. Furthermore, the present invention only uses a one up converter to directly compute the motion vectors for quickly generating interpolated frames so as to enhance practicability of a hold-type display device functioning as an image output device of the MPEG video.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for displaying picture images on a display panel, the picture images being formed by frames, the frames comprising:
at least one I-frame (inter-frame) which provides a full picture image;
at least one P-frame (predict frame) which provides both motion vectors and a partial picture image, the partial picture image provided by the P-frame being substantially different from a full picture image of a directly preceding I or a partial picture image of a directly preceding P-frame, the motion vectors of the P-frame being referenced to the directly preceding I or P-frame; and
at least one B-frame (bi-direction predict frame) which provides only motion vectors, the motion vectors of the B-frame being referenced to both a directly preceding I or P-frame and a directly following I or P-frame;
the method comprising:
interpolating at least one frame between two consecutive frames using motion vectors between the two frames so as to increase a frame rate of the picture images.

2. The method of claim 1 wherein the interpolated frame is generated by dividing the motion vectors stored in the P-frame or the B-frame.

3. The method of claim 1 wherein the I-frame, P-frame and B-frame are generated by decoding image signals using an MPEG decoder, and the interpolated frame is generated by an up converter.

4. The method of claim 1 wherein the display panel is a hold-type display panel.

5. The method of claim 1 wherein the display panel is a PDP (plasma display panel) or an LCD (liquid crystal display) panel.

6. An MPEG system for displaying picture images on a display panel, the picture images being formed by frames, the frames comprising:
at least one I-frame (inter-frame) which provides a full picture image;
at least one P-frame (predict frame) which provides both motion vectors and a partial picture image, the partial picture image provided by the P-frame being substantially different from a full picture image of a directly preceding I or a partial picture image of a directly preceding P-frame, the motion vectors of the P-frame being referenced to the directly preceding I or P-frame; and
at least one B-frame (bi-direction predict frame) which provides only motion vectors, the motion vectors of the B-frame being referenced to both a directly preceding I or P-frame and a directly following I or P-frame;
the MPEG system comprising:
an MPEG decoder for decoding image signals so as to generate the frames; and
an up converter for interpolating at least one frame between two consecutive frames using motion vectors between the two frames so as to increase a frame rate of the picture images.

7. The MPEG system of claim 6 wherein the interpolated frame is generated by dividing the motion vectors stored in the P-frame or the B-frame.

8. The MPEG system of claim 6 wherein the display panel is a hold-type display panel.

9. The MPEG system of claim 6 wherein the display panel is a PDP (plasma display panel) or an LCD (liquid crystal display) panel.
